(19) United States
(12) Patent Application Publication
(10) Pub. No.: US 2005/0082508 A1
(43) Pub. Date: Apr. 21, 2005

(54) Gas release valve for paintball marker

(76) Inventors: David F. Dziob, Meriden, CT (US); Antonin Blazek, Southington, CT (US)

Correspondence Address: ALIX YALE & RISTAS LLP, 750 MAIN STREET, SUITE 1400, HARTFORD, CT, 06103, US

(21) Appl. No.: 10/689,134

(22) Filed: Oct. 20, 2003

(51) Int. Cl. F16K 15/00

(52) U.S. Cl. 251/323; 251/339

(57) ABSTRACT

A gas release valve for a paintball marker employs a uniquely configured gas flow passage to improve gas flow through the valve and enhance the performance and efficiency of the marker. A short axial intake portion of the gas flow passage meets an angled exhaust portion at an angle of approximately 120°. A transition surface at the intersection of the intake and exhaust portions is at least partially defined by a portion of a sphere. The valve body defines an internal spring chamber in which an elastic o-ring engages a radial groove on the valve stem to hold the valve bias spring in compressed relationship inside the spring chamber. The o-ring also seals the valve stem to the valve body and supports the valve during reciprocation. The disclosed valve configuration improves the efficiency and ease of assembly and disassembly of the gas release valve.

### BACKGROUND OF THE INVENTION

1. Field of the Invention

This invention relates to pneumatically operated projectile launching devices and more particularly to a gas release valve for such a projectile launching device configured to significantly improve the efficiency of gas flow through the valve.

2. Description of the Related Art

Paintball is a popular recreational activity that may be played in a variety of indoor or outdoor environments. Typically, the object of the game is to capture the flag of an opposing team. Players are eliminated when “marked” by paint from a pneumatically fired paint ball. The ball is designed to rupture and splatter paint on the stricken player. The equipment used to fire the paintballs are referred to as “markers”. Paintball markers launch the paintballs by releasing a burst of gas (typically CO₂, compressed air or Nitrogen) under pressure into a barrel behind the paintball projectile.

The development of paintball markers has been characterized by continuing efforts to improve their ease of use, reliability, rate of fire, accuracy and efficiency. Efficiency as used in the context of this application is intended to describe the quantity of compressed gas required to propel a paintball projectile at a predetermined velocity. The quantity of gas used is a function of the input pressure, which is adjusted by a regulator between the reservoir of compressed gas and the internal mechanisms of the marker. Generally speaking, higher input pressure translates into higher paintball velocity from the marker. The rules of organized paintball games typically restrict the maximum velocity to between 280 and 300 feet per second close, e.g., within 1 to 2 feet of the muzzle of the paintball marker. The quantity of gas used to propel a paintball to this pre-determined velocity is also a function of how long the gas release valve is open, also referred to as dwell. Dwell and input pressure are the principal variables in determining the velocity with which a paintball marker propels a paintball. For a given input pressure, longer dwell releases a greater volume of gas and generally produces higher velocities. For a given dwell, higher input pressures generally produce a greater volume of gas and generally result in higher velocities.

Generally speaking, it is desirable for a paintball marker to have a high rate of fire. To accomplish a high rate of fire, the duration of each firing cycle should be as short as possible. The desirability of short firing cycles indicates that the dwell should ideally be as short as possible while maintaining an adequate muzzle velocity. In addition to prolonging the cycle time, excessively long dwell is undesirable because it can cause “blow back” which can force the next paintball back up the feed tube and contribute to ball breakage or “chopping”.

Efficiency is important to a paintball player because the power source for the paintball marker is a cartridge or bottle of compressed gas. The cartridge may be mounted directly to the marker or attached to the player with a hose leading to the marker (a “remote setup”). Continuing efforts have been made to reduce the size and weight while increasing the capacity of these cartridges or bottles. However, their capacity is inherently limited and a player can quite literally run out of gas. A paintball marker with improved efficiency may permit either reduction in the size and therefore weight of the compressed gas reservoir or permit the firing of more shots from a gas reservoir of a given size, or both.

Most paintball markers share some common components and are similar in some ways to a firearm or airgun. For example, the paintball projectile is fired out of a barrel, which extends from a generally closed breech end to an open muzzle end. The paintball marker typically includes a grip and utilizes a trigger to initiate launching of the paintball projectile. A reservoir or magazine of paintball projectiles (also referred to as a hopper) is typically mounted above the breech of the paintball marker. Paintballs are fed into the breech of the marker from the hopper. The hopper may be equipped with a battery powered feed mechanism. Gravity fed systems are also common.

Many paintball markers are semi-automatic, e.g., a new projectile is loaded into firing position automatically, immediately after launch of a preceding paintball. Such paintball markers typically utilize a reciprocating bolt. The bolt cycles between a loading position in which the outlet of the paintball hopper is uncovered, permitting a paintball to drop into the breech of the paintball marker; and a launch position in which the bolt moves toward the muzzle of the marker, covering the hopper outlet. When in the “firing” position, the bolt re-directs a charge of compressed gas released from a chamber in the marker to propel the paintball out the muzzle end of the barrel. Actuation of the gas release valve opens a passage in the valve communicating between the compressed gas chamber and the bolt. The rate of gas flow through the gas release valve is a critical component of the overall firing cycle time. The expanding gas of the propellant charge transfers energy to the projectile, expelling it from the barrel of the marker.

Compressed gas is also used to reciprocate the primary moving components of the paintball marker. One reciprocating component is the bolt, which reciprocates between a loading position and a firing position as described above. The loading position is rearward relative to the open end of the barrel from the firing position. A further reciprocating component is the hammer. The hammer is connected to the bolt such that the hammer and bolt reciprocate in unison. The hammer moves forward to open the gas release valve and move the bolt to its firing position. Most paintball markers use compressed gas to return the hammer to its “cocked” position. This rearward movement of the hammer closes the gas release valve and cycles the bolt back to its loading position.

Many of the more popular, semiautomatic paintball markers use an electronically actuated solenoid valve to release pulses of compressed gas to cycle the hammer and bolt. The hammer is connected by a shaft to an air-actuated piston. The solenoid valve has two gas flow passageways communicating with chambers on either side of the piston. Actuating the solenoid valve to release compressed gas through a first of the passages allows compressed gas to flow into a chamber behind the piston, moving the hammer forward to place the bolt in the firing position and actuate the gas release valve. The solenoid is then actuated to close the first passage and open a second passage to release compressed gas into a chamber in front of the piston, causing the hammer to reverse its direction, close the gas release valve and return the bolt to its loading position. The time the hammer holds the gas release valve open is often referred to as “dwell”.

The standard design for the gas release valve is a valve body defining an axial through bore for reception of a reciprocating valve member. The valve member is spring biased toward a closed position by an external helical coil spring extending between the end of the valve away from the hammer and bearing against a cap screwed into the cylindrical bore containing the valve body and the hammer. When in the closed position, the valve member extends beyond the end of the valve body toward the hammer. The axial end of the valve body adjacent the hammer will hereinafter be referred to as the “actuation end”, while the axial end of the valve body defining the intake port will be referred to as the “intake end”. The valve member reciprocates in the valve body between a closed position and an open or actuated position. In the closed position, the valve stem extends beyond the actuation end of the valve body. A seal member is coupled to the opposite end of the valve stem. The seal end of the valve member has a spring seat on one side and a valve seal on the other side. A cylindrical coil spring in the compressed gas chamber fits over the spring seat to bias the seal against a seal seat at the valve inlet port to close the valve. When the hammer moves forward, it strikes the protruding actuation end of the valve member, moving the seal of the valve away from its seat against the spring bias to open the valve.

Pressurized gas flows around the seal end of the valve member and into the intake port defined by the valve body. The propellant charge flows through a gas flow passage connecting the inlet port to an exhaust port and into the flow passages of the bolt to expand behind the paintball. The flow passage through the valve is typically defined by the intersection of two perpendicular bores. An axial bore communicating with the inlet port defines the intake portion of the flow passage. A bore perpendicular to the axis of the valve body and communicating with the exhaust port defines the exhaust portion of the flow passage. This gas release valve configuration has a number of drawbacks. The spring seat has a number of sharp edges that produce turbulence in gas flowing around the seal end of the valve member. The cylindrical coil spring in the compressed gas chamber reduces the volume of the chamber and causes additional turbulence. The perpendicular intersection of the intake and exhaust portions of the flow passages force the gas to make an abrupt change of direction, sapping the propellant charge of momentum. Also, the intersection of perpendicular bores includes unnecessary dead volume that must be filled by the expanding propellant charge before sufficient force is transferred to the projectile to cause it to move out of the barrel. Still further, the intersection of perpendicular bores typically include turbulence-causing corners. Reduction in the turbulence in the flow passage is likely to improve the rate of gas flow through the passage. A reduction in the “dead” or unnecessary volume of the flow passage will reduce the quantity of gas required to reach a given level of projectile-moving force.

Recently issued U.S. Pat. No. 6,418,920 describes a gas release valve design that addresses some of the deficiencies of the gas release valve discussed above. The '920 patent discloses moving the valve bias spring from the intake end to the actuation end of the valve. Further, the '920 patent discloses an aerodynamic configuration for the seal end of the valve member projecting into the compressed gas chamber. Removal of the bias spring and the aerodynamic shape of the valve member seal end smoothes the flow of gas around the valve seal and through the gas release valve. The '920 patent approaches the problem of improving gas flow through the valve body by providing multiple exhaust ports connected to an annular recess surrounding the body of the valve. The theory behind this configuration is that multiple exhaust ports will allow greater gas flow than a single exhaust port. The flow passage disclosed in the '920 patent is defined by a perpendicular intersection of the axial intake portion with the several exhaust portions.

The perpendicular passage intersections disclosed in the '920 patent have sharp, turbulence-causing edges and require an abrupt change of gas flow direction. The multiple exhaust passages, annular recess and space around the valve body dramatically increase the dead volume in the valve. Further, only one, if any, of the exhaust ports is aligned with the gas flow passage leading to the bolt. Gas flow from any of the other exhaust ports to the bolt requires at least one, and sometimes several, changes of direction. It is well understood that a change of direction in a flow of fluid saps energy from the fluid. The internal turbulence, multiple changes of direction and increased dead volume of the '920 flow passage design result in less than optimal fluid flow through the valve. A further deficiency of the valve configuration disclosed in the '920 patent is that the valve stem is largely unsupported as it passes through the center of the valve body. This unsupported configuration presents the possibility of valve seal misalignment with the intake port. Misalignment of the seal with its seat may result uneven seal wear and/or in leakage through the valve.

### SUMMARY OF THE INVENTION

These and other deficiencies of the prior art are addressed by particular aspects of a gas release valve in accordance with the present invention. An exemplary embodiment of a gas release valve minimizes the dead volume of the gas flow passage through the valve by employing a flow passage in which the intake and exhaust portions meet at an angle greater than 90°. The flow passage is primarily an angled bore along a nearly direct path between the intake and exhaust ports defined by the valve body. Such a configuration shortens the overall length and thereby the volume of the flow passage. The non-perpendicular intersection of the intake and exhaust portions of the flow passage is less abrupt, thereby reducing energy lost to turbulence relative to the intersection of perpendicular gas flow passages.

Another aspect of the present invention involves a gradual transition at the intersection of the intake and exhaust portions of the gas flow passage. The present invention smoothes the transition from the intake to exhaust portion by defining part of the intersection as a concave curved surface. The illustrated embodiment employs a portion of a sphere to define the concave curved surface.

The illustrated exemplary embodiment of a gas release valve employs a valve member with an aerodynamically shaped seal member to smooth the flow of gas past the seal and into the gas flow passage. The aerodynamic valve seal is integrally connected to the valve stem and configured to cover the intake port. The valve stem defines a radial groove toward the end of the valve stem opposite the valve seal. The valve stem extends beyond the actuation end of the valve body for actuation by the hammer.

The angled configuration of the exhaust portion of the flow passage allows the valve body to define a valve guide bore which extends much closer to the intake port than was possible in the prior art. This provides better support to the valve member. The valve guide bore includes a first portion configured to closely receive the valve stem for reciprocation therein. A second portion of the valve guide bore has a larger diameter and defines a spring chamber internal to the valve body. A spring is compressed between a spring retainer on the valve stem and the valve body to bias the valve member toward the closed position. In accordance with a further aspect of the present invention, the spring retainer is a resilient elastic o-ring with an inside diameter selected to securely engage the groove defined in the valve stem. A radially inwardly projecting lip partially encloses the spring chamber and defines a valve stem opening through which the projecting end of the valve stem extends. The o-ring spring retainer provides a slidable sealed engagement with the inside surface of the spring chamber, effectively sealing the valve bore. The o-ring provides further alignment and support for the reciprocating valve.

An object of the present invention is to provide a new and improved gas release valve for a paintball marker that minimizes the loss of energy attributable to changes of direction and turbulence.

Another object of the present invention is to provide a new and improved gas release valve for a paintball marker that minimizes the volume of the flow passage through the valve.

A further object of the present invention is to provide a new an improved gas release valve for a paintball marker having a reduced part count.

A still further object of the present invention is to provide a new and improved gas release valve for a paintball marker having enhanced ease of assembly and which is easily disassembled for cleaning and service.

### BRIEF DESCRIPTION OF THE DRAWINGS

FIG. 1 is a side view, partially cut away, of a prior art paintball marker which may be fitted with a gas release valve in accordance with the present invention;

FIG. 2 is an exploded top view of a prior art gas release valve;

FIG. 3 is a preassembly top view of the prior art gas release valve of FIG. 2 shown with an end cap;

FIG. 4 is an exploded side view of a valve body in section and valve member of a first illustrated embodiment of a gas release valve in accordance with the present invention;

FIG. 5 is a side sectional view through an assembled illustrated embodiment of the gas release valve in accordance with the present invention;

FIG. 6 is a side sectional view through a further alternative embodiment of a valve body for a gas release valve in accordance with the present invention;

FIG. 7 is a top perspective view of an assembled embodiment of the gas release valve;

FIG. 8 is a plan view of a C-clip used in conjunction with the valve member of FIGS. 4, 5 and 8; and

FIG. 9 is a side sectional view through an alternative assembled embodiment of a gas release valve according to aspects of the present invention.

### DETAILED DESCRIPTION OF THE PREFERRED EMBODIMENT

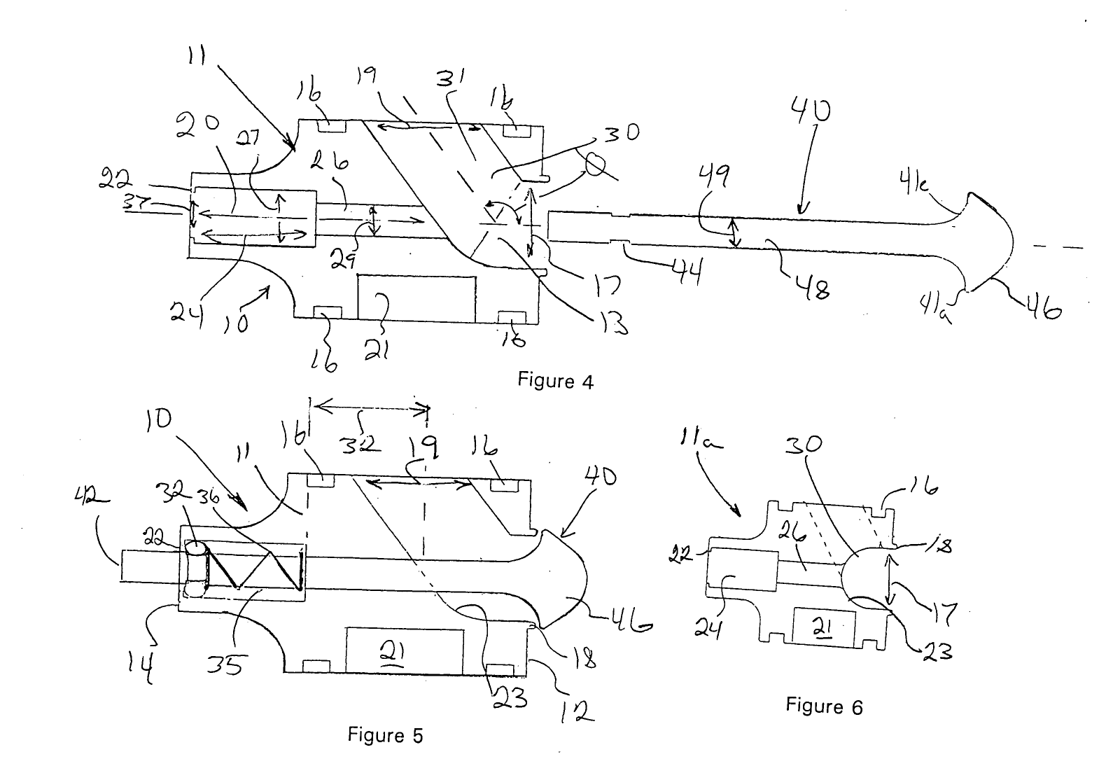

Illustrated embodiments of a gas release valve in accordance with the present invention will be described with reference to FIGS. 4-9.

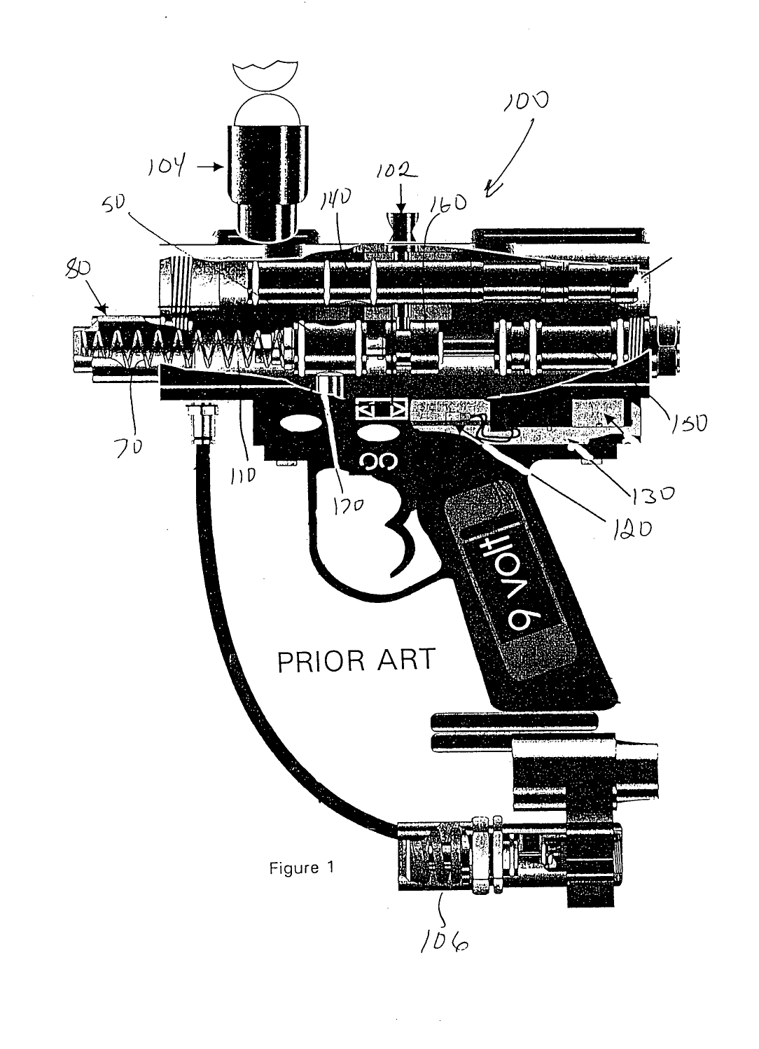

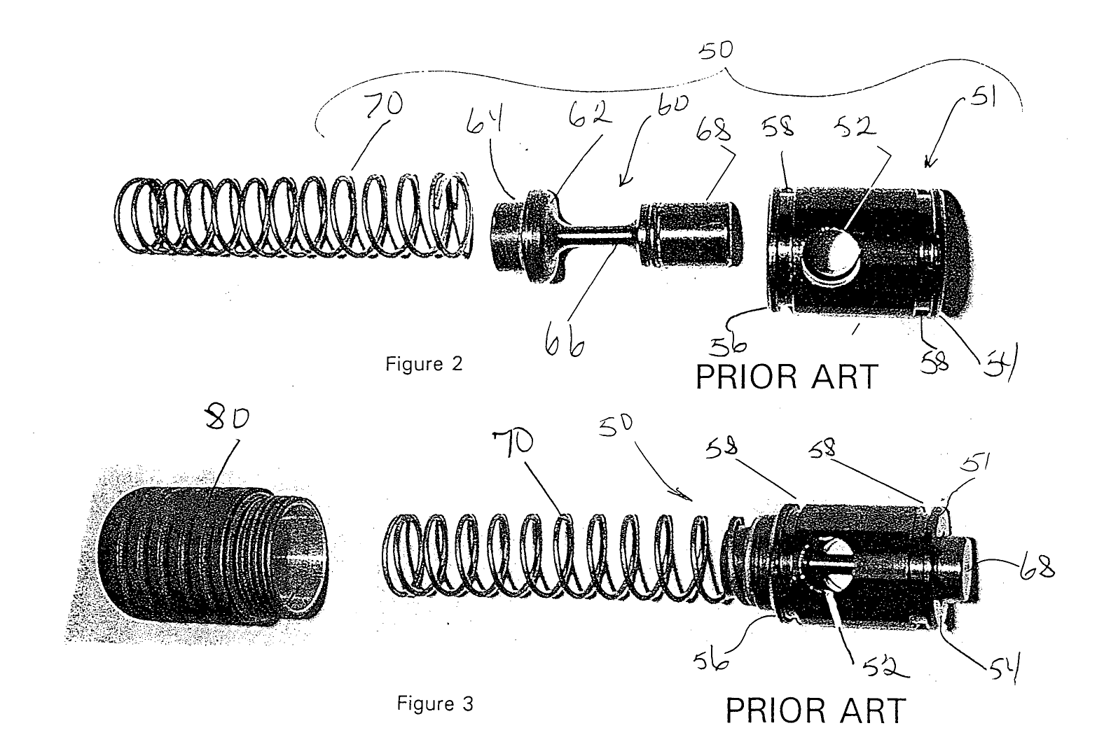

FIG. 1 illustrates a prior art paintball marker 100 that may be equipped with the gas release valve embodiments shown in FIGS. 4-6. FIGS. 2 and 3 show exploded and pre-assembly top views of a prior art gas release valve 50 of the type that may be replaced by the illustrated gas release valve shown in FIGS. 4-6. A regulator 106 provides compressed gas to several chambers of the paintball marker 100 of FIG. 1 at a predetermined pressure. The compressed gas fills a compressed gas chamber 110 containing the valve bias spring 70 toward the left side of FIG. 1. Compressed gas also fills an internal chamber (not illustrated) in communication with a solenoid valve 130. An electronic circuit 120 controls actuation of the solenoid valve 130. A reciprocating bolt 140 is coupled to a reciprocating hammer 160 by a bolt pin 102 passing through the bolt and engaging a radial groove in the hammer. A hopper (not illustrated) feeds paintballs to the breech of the paintball marker through feedneck 104. The gas release valve 50 is inserted axially into the same bore in which the hammer 160 reciprocates. The bias spring 70 is inserted and secured against the seal end of the valve member by cap 80. The valve body 51 defines radial grooves 58 that receive o-rings to seal the valve body 51 against the inside of the bore.

The prior art gas release valve 50 is best described with reference to FIGS. 2 and 3. The prior art gas release valve 50 has three primary components: a bias spring 70, a valve member 60 and a valve body 51. Two intersecting perpendicular bores define the gas flow passage through the valve body 51. An axial bore defines the intake port and the intake portion of the gas flow passage. A perpendicular bore through the valve body 51 defines an exhaust port 52 and an exhaust portion of the flow passage in communication with the exhaust port. The perpendicular bore actually defines two openings through the side of the valve body 51. A locating pin 170 threads through the frame of the marker to enter one of the openings to maintain the gas release valve 50 in an orientation such that the exhaust port 52 is aligned with a gas flow passage in the marker body that transmits propellant gas to the bolt 140. The prior art valve member 60 has a spring seat 64 and seal 62 at one end coupled to an actuation end 68 by a valve stem 66. As best seen in FIG. 3, the bias spring 70 engages the spring seat 64 and is compressed against the valve member 60 by a cap 80 covering the end of the compressed gas chamber 110.

Pulling the trigger of the illustrated paintball marker 100 initiates a timed sequence in which the electronic circuit 120 actuates the solenoid valve 130 releasing compressed gas into a chamber behind a piston 150 coupled to the hammer 160. The compressed gas expands behind the piston 150 pushing the hammer 160 forward to move the bolt 140 into its firing position while the hammer 160 impacts the actuation end 68 of the valve member 60. The valve seal 62 is moved away from its seat and releases propellant gas into the gas flow passage defined by the valve body 51. After a dwell time determined by the electronic circuit 120, the solenoid valve 130 is activated to close the first passage and open a second passage releasing gas in front of the piston 150 coupled to the hammer 160. This cycles the hammer 160 and bolt 140 rearwardly, allowing the gas release valve 50 to close and another paintball projectile to feed into the breech. The dwell time is adjustable by manipulating switches or buttons coupled to the electronic circuit 120. The pressure of gas fed to the marker 100 is adjustable by manipulating the regulator 106.

Exemplary embodiments of a gas release valve 10 in accordance with aspects of the present invention are illustrated in FIGS. 4-9. FIG. 4 is a side sectional view through an exemplary valve body 11 and valve member 40 in a pre-assembly configuration. A short axial bore entering the valve body 11 from the inlet end 12 defines an inlet port 17 and an inlet portion 13 of the gas flow passage 30. An outward axially extending circumferential lip defines a seal seat 18 surrounding the inlet port 17. An exhaust portion 31 of the gas flow passage meets the inlet portion 13 of the gas flow passage 30 at an angle Ø greater than 90°. In the illustrated embodiment, the inlet and exhaust portions of the gas flow passage 30 meet at an angle Ø of approximately 120°. The exhaust portion 31 of the gas flow passage 30 is much longer than the inlet portion 13. The illustrated gas flow passage 30 presents a shorter and substantially direct path between the inlet port 17 and the exhaust port 19.

In accordance with a further aspect of the present invention, the intersection between intake and exhaust portions of the gas flow passage 30 is at least partially defined by an arcuate transition surface 23. As best seen in FIG. 6, the transition surface 23 is defined by a portion of a sphere. A ball-end mill may be used to form such a surface. The obliquely angled and rounded intersection of the intake and exhaust portions of the gas flow passage 30 achieves at least two objectives of the present invention. First, the path between the intake and exhaust ports 17, 19 is more direct, shortening the gas flow passage 30 and reducing its interior volume. Second, an abrupt (e.g., perpendicular) change of direction is avoided. The curved transition surface 23 at the intersection of the intake and exhaust portions reduces turbulence and aids in changing the direction of the propellant charge. In combination, these attributes of the illustrated exemplary gas flow passage 30 result in significantly enhanced propellant charge flow through the illustrated gas release valve 10.

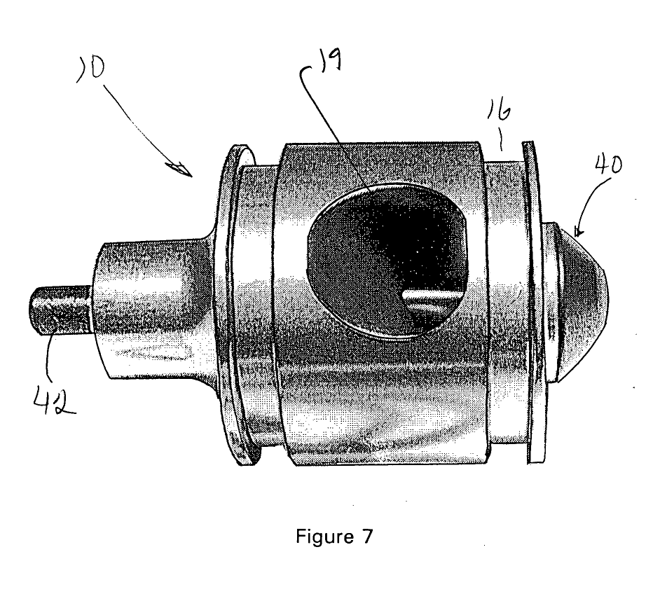

The illustrated gas release valve 10 is a replacement part and therefore must conform to the configuration of the paintball marker into which it will be installed. The circular exhaust port defined by the perpendicular bore of the prior art valve 50 matched the circular internal passage leading to the bolt in the marker 100 of FIG. 1. Merely shifting a circular boring tool to the angle Ø of the illustrated exhaust portion 31 would produce a decidedly non-circular exhaust port 19 that would poorly match the configuration of the internal passage to the bolt. A poorly matched valve body exhaust port 19/internal passage interface would result in turbulence. One aspect of the present invention relates to matching the shape of the exhaust port 19 to that of the marker internal passage by using a smaller diameter boring tool to form the exhaust portion 31. The tool is moved laterally, or across the valve body 11 to provide an exhaust port 19 that is more nearly circular. The resulting exhaust port configuration is best seen in FIG. 7. Other methods of matching the configuration of the exhaust port 19 defined by an angled gas flow passage are possible and are intended to be encompassed by this patent.

The illustrated gas flow passage 30 configuration makes a central portion 32 of the valve body 11 available for a valve guide bore 20. The valve guide bore 20 of the illustrated embodiment has a greater axial length and extends to a point far closer to the inlet port 17 than is possible with the prior art configurations. An extended axial length and location closer to the inlet port 17 increases the stability and precision with which the valve member 40 is guided during valve actuation. The o-ring 32 sliding engagement within the spring chamber 35 provides further support and guidance for the valve member during reciprocation. The valve guide bore 20 in the illustrated embodiment is aligned along the axis of the valve body 11. The valve guide bore 20 has a first portion 26 with a first diameter 29 sized to closely receive and slidably support the valve stem 48. A second portion 24 of the valve guide bore 20 increases to a second diameter 27 to define a spring chamber 35 internal to the valve body 11.

An exemplary valve member 40 incorporates an aerodynamically configured seal 46 integrally extending from the valve stem 48. The valve seal 46 incorporates several aerodynamic features. The outer surface of the valve seal 46 facing the compressed gas chamber 110 is a smooth, convex and symmetrical surface. A radius defines the peripheral lip 41a defining the transition from the outer surface to the inner surface of the valve seal. Additionally, a concave radius 41c defines the transition from the peripheral lip to the valve stem 48. This concave radiused surface reduces dead volume behind the valve seal 46, directs gas flow toward the valve flow passage 30 and reduces turbulence in the gas flow.

The valve stem 48 has a substantially constant diameter 49 with the exception of a radial groove 44 proximate the actuation end 42 of the valve stem 48. In accordance with a further aspect of the present invention, a resilient elastic o-ring 32 is selected to have an inside diameter and elastic properties that allow it to securely engage with the valve stem 48 at the radial groove 44. When engaged with the valve stem 48, the o-ring 32 acts as a spring retainer, sliding valve guide and spring chamber seal. A cylindrical coil compression spring 36 is compressed between the o-ring 32, acting as a spring retainer, and the valve body inside the spring chamber 35. A radially inward projecting lip 22 at the actuation end 14 of the valve body 11 partially encloses the spring chamber 35.

As shown in FIG. 5, when the valve 10 is assembled, the o-ring 32 is engaged with the valve stem groove 44 to move with the valve member 40. The cylindrical coil spring 36 is arranged to bias the valve member 40 toward its closed position. The o-ring 32 is selected to slidably engage the inside surface of the spring chamber 35. The o-ring 32 provides a substantially sealed relationship between the valve member 40 and the valve body 11. This reduces the possibility of contamination entering the spring chamber 35 from the actuation end and also minimizes the flow of propellant gas through the valve guide bore 20 from the intake end 12 of the valve body 11.

The valve body 11 defines two radial grooves 16 on the outside surface for reception of o-rings (not illustrated) that seal the valve body 11 in its bore inside the marker body as shown in the prior art. The illustrated valve body 11 defines a locator pin bore 21 for reception of a locator pin to maintain the valve accurately in position within the marker body. In other words, the valve body 11 is secured in the bore of the marker body so that the exhaust port 19 is in registration with a gas flow passage leading to the bolt.

Further aspects of the present invention relate to a method for assembling the illustrated gas release valve 10. The first portion 26 of the valve guide bore 20 has a first diameter 29 a few thousandths of an inch larger than the diameter 49 of the valve stem 48. The second portion 26 of the valve guide bore 20 has a second, larger diameter 27 to define the spring chamber 35. The radially inward projecting lip 22 defines a valve stem opening 37 having a third diameter larger than the diameter 29 of the valve stem bore first portion 26 but smaller than the diameter 27 of the spring chamber 35. The valve bias spring 36 is a cylindrical coil spring with an inside diameter sized to fit over the valve stem 48 and an outside diameter that is axially receivable through the valve stem opening 37 defined by the lip 22.

Assembly of the gas release valve 10 illustrated in FIGS. 4-7 is as follows:
1) the coil bias spring 36 is inserted into the spring chamber 35 through the valve stem opening 37;
2) the o-ring 32 is inserted through the valve stem opening 37 into a position between the lip 22 and one end of the coil bias spring 36; (An advantage of an o-ring 32 as a spring retainer is that it may be deformed to pass through the valve stem opening 37 and spring back to its o-ring shape in the spring chamber 35.); and
3) the valve member 40 is inserted through the inlet port 17 and inlet portion 13 of the gas flow passage 30, through the first portion 26 of the valve guide bore 20 and through the coil bias spring 36 in the spring chamber 35, when the actuation end 42 of the valve stem 48 encounters the o-ring 32, the o-ring deforms outwardly to pass over the valve stem 48 until the o-ring 32 engages the radial groove 44 on the valve stem 48, the o-ring snaps into the groove 44 and is engaged to move with the valve member 40.

It will be understood that there are two forces or two levels of force at work in the assembly and functionality of the illustrated o-ring 32 spring retainer and valve stem 48 relationship. A first level of force is required to push the valve stem 48 through the opening in the o-ring 32. The o-ring 32 engages the groove 44 in the valve stem 48 with a second level of force. This second, or retaining force is sufficient to oppose the biasing force exerted on the valve member 40 by the compression spring 36 throughout the travel of the valve member 40 during valve actuation. Removal of the valve member 40 from the o-ring 32 is accomplished by pushing or pulling the valve member 40 away from the inlet end of the valve body 11 with sufficient force to overcome the retaining force between the o-ring 32 and the valve stem 48. The o-ring 32 expands to pass over the valve stem 48, freeing the valve member 40. A hook or similar device (not illustrated) can be used to extract the o-ring 32 from the spring chamber 35 and remove the spring 36. The inventive configuration provides ease of assembly and disassembly as well as a sealed relationship between the valve member 40 and the valve body 11.

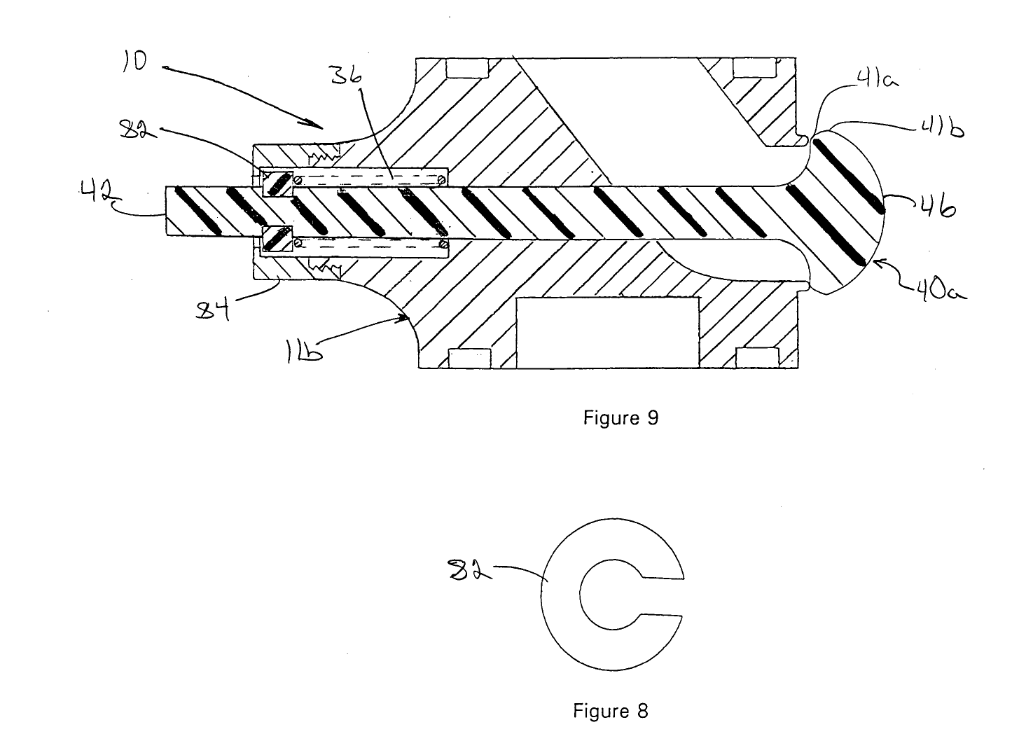

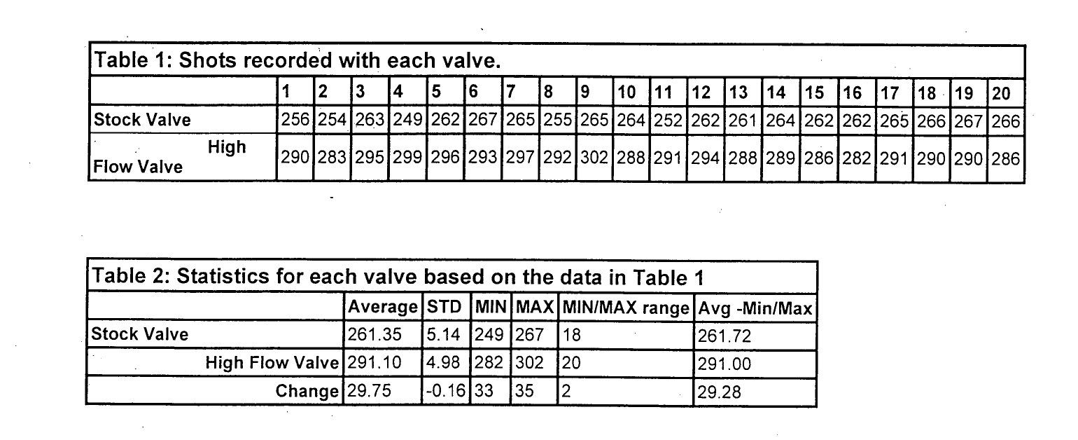

FIGS. 8 and 9 illustrate an alternative embodiment of a gas release valve 10 according to aspects of the present invention. The gas release valve of FIGS. 8 and 9 differs from that shown in FIGS. 4-7 in the shape of the valve member 40a and in the configuration of the valve body 11a in the vicinity of the spring chamber 35. As an alternative to the O-ring 32 of FIG. 5, the valve embodiment of FIG. 9 employs a plastic C-clip 82 configured to engage the valve stem 48 at the groove 44. The relatively rigid C-clip 82 requires that the lip 22 at the actuation end of the valve body be provided on a separate cap 84 threaded to the valve body 11a. The square profile of the C-clip provides a more positive engagement of the groove 44 than the round profile of the O-ring 32. In this alternative construction, the cap 82 is threaded to the valve body 11a following insertion of the spring 36 and installation of the C-clip 82. The C-clip 82 bears against the inside of the lip 22 to define a closed position for the valve member 40a.

The valve member 40a includes an alternative aerodynamic configuration for the valve seal 46. The valve member 40a includes the radiused lip 41a and the concave surface 41c of the valve 40 shown in FIGS. 4 and 5. Valve member 40a further includes an angled transition surface 41b blending the outer hemispherical surface of the valve seal with the radiused lip 41a. Together, these features smooth the flow of gas around the valve seal 46 and through the inlet 17.

The inventive configurations produce a surprising improvement in paintball marker performance relative to the gas release valve illustrated in FIGS. 2 and 3. In a marker known as the Impulse™ Adrenaline™, replacing the stock valve with a gas release valve in accordance with the present invention and making no other changes to the marker improved the average muzzle velocity of approximately 30 to 40 feet per second, an increase in excess of approximately 11%. The spread between the fastest and slowest shots in each test grouping decreased relative to the improved velocity. In other words, standard deviation for the shot grouping using the inventive valve was less than that for the shot grouping using the stock valve (see Table 2). Installation of the inventive gas release valve dramatically improved muzzle velocity with all other aspects of the paintball marker remaining the same. Further, the shots are more consistent using the inventive valve.

This improved performance allows the input pressure and/or the dwell to be reduced for a given muzzle velocity. Taking either of these actions or a combination of the two will result in more shots for a given reservoir of propellant gas. This improved performance in terms of efficiency is a highly desirable result of the present invention.

While a preferred embodiment of the foregoing invention has been set forth for purposes of illustration, the foregoing description should not be deemed a limitation of the invention herein. Accordingly, various modifications, adaptations and alternatives may occur to one skilled in the art without departing from the spirit and the scope of the present invention.

1. A valve comprising:
a valve body having a first end, a second end, an axis, and an outside surface extending between said first and second ends, said valve body defining an intake port surrounded by a seal seat at said first end, an exhaust port on said outside surface, a passageway connecting the intake port and the exhaust port, and a valve guide bore, said passageway comprising an intake portion communicating with said intake port and an exhaust portion communicating with said exhaust port and intersecting said intake portion at an angle of greater than 90°; and
a valve member comprising a valve stem and a seal coupled to the valve stem, said valve stem being slidably received in said valve guide bore and resiliently biased toward a closed position wherein said seal abuts said seal seat to block gas flow through said intake port and said valve stem protrudes from said valve body second end.

2. The valve of claim 1, comprising a spring and said valve guide bore comprises a first portion having a first diameter selected to closely receive said valve stem and a second portion having a second diameter greater than said first diameter, said second portion defining a spring chamber,
wherein said spring is arranged in said spring chamber and engaged with said valve stem to bias said valve member toward said closed position.

3. The valve of claim 1, comprising a spring, a spring retainer radially extending from said valve stem and said valve guide bore comprises a first portion having a first diameter selected to closely receive said valve stem and a second portion having a second diameter greater than said first diameter, said second portion defining a spring chamber,
wherein said spring is arranged in said spring chamber and engaged with said valve stem to bias said valve member toward said closed position, said spring being maintained in compression between said spring retainer and said valve body.

4. The valve of claim 1, comprising:
a spring;
said valve stem defining a radial groove;
a spring retainer comprising a resilient member engaged in said valve stem radial groove;
and said valve guide bore comprises a first portion having a first diameter selected to closely receive said valve stem and a second portion having a second diameter greater than said first diameter, said second portion defining a spring chamber extending between a spring chamber second end adjacent said valve body second end and a spring chamber first end, said spring chamber second end having a radially inward projecting lip defining a valve stem opening through which said valve stem protrudes, said valve stem opening having a third diameter smaller than said second diameter but greater than said first diameter,
wherein said spring is arranged in said spring chamber and engaged with said valve stem to bias said valve member toward said closed position, said spring being maintained in compression between said spring retainer and said valve body and said spring retainer resting against said lip when said valve member is in said closed position.

5. The valve of claim 1, wherein said valve guide bore comprises a first portion having a first diameter selected to closely receive said valve stem and a second portion having a second diameter greater than said first diameter, said second portion defining a spring chamber extending between a spring chamber second end adjacent said valve body second end and a spring chamber first end, said spring chamber second end having a radially inward projecting lip defining a valve stem opening through which said valve stem protrudes, said valve stem opening having a third diameter smaller than said second diameter but greater than said first diameter, said valve stem having a stem outside diameter and defining a radial groove, said valve comprising:
a cylindrical helical spring having a spring inside diameter and a spring outside diameter, said spring inside diameter being greater than said stem outside diameter and said spring outside diameter being smaller than said third diameter;
a resilient member engageable in said valve stem radial groove;
wherein said spring is inserted into said spring chamber through said valve stem opening, said resilient member is deformed to pass through said valve stem opening after insertion of said spring, said valve stem is inserted into said valve body first end to pass through said valve guide bore first portion and enter said spring chamber from said first end, said valve stem passing through said spring inside diameter and said resilient member to project through said valve stem opening, said resilient member grasping said valve stem at said radial groove,
whereby said spring is captured between said spring chamber first end and said resilient member to bias said valve member toward said closed position

6. The valve of claim 1, wherein said valve guide bore comprises a first portion having a first diameter selected to closely receive said valve stem and a second portion having a second diameter greater than said first diameter, said second portion defining a spring chamber extending between a spring chamber second end adjacent said valve body second end and a spring chamber first end and having a cylindrical inside surface, said spring chamber second end defining a valve stem opening through which said valve stem protrudes, said valve stem having a stem outside diameter and defining a radial groove, said valve comprising:
a spring;
a resilient O-ring having an inside diameter and an outside diameter, said O-ring inside diameter being smaller than said stem outside diameter;
wherein O-ring is engaged with said valve stem at said radial groove, said spring is captured between said O-ring and said spring chamber first end and said O-ring outside diameter is slidingly, sealingly engaged against the spring chamber cylindrical inside surface.

7. The valve of claim 1, wherein an inside surface of said passageway at the intersection of said intake and exhaust portions is at least partially defined by a concave, curved surface.

8. The valve of claim 1, wherein said intake portion comprises a substantially circular axial bore, said exhaust portion comprises a non-circular bore and an inside surface of said passageway at the intersection of said intake and exhaust portions is at least partially defined by a portion of a sphere.

9. The valve of claim 1, wherein said angle of greater than 90° is approximately 120°.

10. The valve of claim 1, wherein said seal comprises a convex outward surface and an inner transition surface comprises a concave circumferential surface extending between a peripheral lip of the seal and the valve stem, said circumferential surface at least partially defined by a first radius greater than a second radius of said valve stem.

11. The valve of claim 10, wherein said peripheral lip comprises a convex circumferential surface extending between said outward surface and said inner transition surface, said convex circumferential surface comprising a radiused surface.

12. A method of assembling a valve comprising:
a valve comprising a valve stem and a seal connected to the stem, said stem having a stem outside diameter and defining a radial groove;
a valve body defining an intake port, an exhaust port, a gas flow passage extending between the intake and exhaust ports and a valve guide bore comprising a first portion having a first diameter selected to closely receive said valve stem and a second portion having a second diameter greater than said first diameter, said second portion defining a spring chamber extending between a spring chamber second end adjacent said valve body second end and a spring chamber first end, said spring chamber second end having a radially inward projecting lip defining a valve stem opening through which said valve stem protrudes, said valve stem opening having a third diameter smaller than said second diameter but greater than said first diameter;
a cylindrical helical spring having a spring inside diameter and a spring outside diameter, said spring inside diameter being greater than said stem outside diameter and said spring outside diameter being smaller than said third diameter;
a resilient member engageable over said valve stem in said valve stem radial groove,
wherein said method of assembly comprises:
inserting said spring into said spring chamber through said valve stem opening;
inserting said resilient member through said valve stem opening after insertion of said spring;
inserting said valve stem into said valve body first end to pass through said valve guide bore first portion and enter said spring chamber from said spring chamber first end, said valve stem passing through said spring inside diameter and said resilient member to project through said valve stem opening, said resilient member grasping said valve stem at said radial groove,
whereby said spring is captured between said spring chamber first end and said resilient member to bias said valve toward said closed position.

13. The method of assembly of claim 12, comprising:
selecting as said resilient member an O-ring having an inside diameter smaller than said stem outside diameter and a radial thickness that will result in an installed outside diameter for the resilient member that will provide a sliding, substantially sealed relationship between the resilient member and an inside surface of the spring chamber.

14. A gas release valve comprising:
a valve body having an intake end, an actuation end, an axis, and a generally cylindrical outside surface extending at least part of an axial distance between said intake and actuation ends, said valve body defining an axial, generally circular intake port surrounded by a seal seat at said intake end, an exhaust port through said generally cylindrical outside surface, a gas flow passage connecting the intake port and the exhaust port, and a valve guide bore, said gas flow passage comprising an intake portion communicating with said intake port and an exhaust portion communicating with said exhaust port, said intake and exhaust portions intersecting at an angle θ of greater than 90°;
a valve member comprising a valve stem and a seal coupled to the valve stem, said valve stem being slidably received in said valve guide bore and resiliently biased toward a closed position wherein said seal abuts said seal seat to block gas flow through said intake port and said valve stem protrudes from said valve body second end.

15. The gas release valve of claim 14, comprising a spring and said valve guide bore comprises a first portion having a first diameter selected to closely receive said valve stem and a second portion having a second diameter greater than said first diameter, said second portion defining a spring chamber internal to said valve body,
wherein said spring is arranged in said spring chamber and engaged with said valve stem to bias said valve toward said closed position.

16. The gas release valve of claim 14, wherein said exhaust port and said exhaust portion are non-circular.

17. The gas release valve of claim 14, comprising a spring and an elastic o-ring, wherein said valve guide bore comprises a first portion having a first diameter selected to closely receive said valve stem and a second portion having a second diameter greater than said first diameter, said second portion defining a spring chamber internal to said valve body and said valve stem defines a radial groove,
wherein said spring is arranged in said spring chamber, said elastic o-ring is engaged with said valve stem at said radial groove and said spring is compressed between said valve body and said elastic o-ring to bias said valve toward said closed position.

18. The gas release valve of claim 14, wherein said angle θ is approximately 120°.

19. The gas release valve of claim 14, comprising
a spring;
said valve stem defining a radial groove;
a spring retainer comprising an elastic member engaged in said valve stem radial groove;
and said valve guide bore comprises a first portion having a first diameter selected to closely receive said valve stem and a second portion having a second diameter greater than said first diameter, said second portion defining a spring chamber extending between a spring chamber second end adjacent said valve body actuation end and a spring chamber first end adjacent said valve guide bore first portion, said spring chamber second end having a radially inward projecting lip defining a valve stem opening through which said valve stem protrudes from the actuation end of said valve body, said valve stem opening having a third diameter smaller than said second diameter and greater than said first diameter,
wherein said spring is arranged in said spring chamber and maintained in compression between said spring retainer and said valve body to bias said valve member toward said closed position.

20. The valve of claim 14, wherein said valve guide bore comprises a first portion having a first diameter selected to closely receive said valve stem and a second portion having a second diameter greater than said first diameter, said second portion defining a spring chamber extending between a spring chamber second end adjacent said valve body actuation end and a spring chamber first end adjacent said valve guide bore first portion, said spring chamber second end having a radially inward projecting lip defining a valve stem opening through which said valve stem protrudes from the valve body actuation end, said valve stem opening having a third diameter smaller than said second diameter but greater than said first diameter, said valve stem having a stem outside diameter and defining a radial groove, said valve comprising:
a cylindrical helical spring having a spring inside diameter and a spring outside diameter, said spring inside diameter being greater than said stem outside diameter and said spring outside diameter being smaller than said third diameter;
a resilient member engageable in said valve stem radial groove;
wherein said spring is inserted into said spring chamber through said valve stem opening, said resilient member is deformed to pass through said valve stem opening after insertion of said spring, said valve stem is inserted into said valve body first end to pass through said valve guide bore first portion and enter said spring chamber from said first end, said valve stem passing through said spring inside diameter and said resilient member to project through said valve stem opening, said resilient member grasping said valve stem at said radial groove,
whereby said spring is captured between said spring chamber first end and said resilient member to bias said valve member toward said closed position.

21. The gas release valve of claim 14, wherein said valve guide bore comprises a first portion having a first diameter selected to closely receive said valve stem and a second portion having a second diameter greater than said first diameter, said second portion defining a spring chamber extending between a spring chamber second end adjacent said valve body actuation end and a spring chamber first end adjacent said valve guide bore first portion, said first portion being axially spaced from both the intake end and the actuation end of said valve body.
